(19) United States
(12) Patent Application Publication
(10) Pub. No.: US 2017/0070788 A1
(43) Pub. Date: Mar. 9, 2017

(54) APPARATUS AND METHOD FOR RECEIVING A SIGNAL

(71) Applicant: THOMSON LICENSING, Issy Les Moulineaux (FR)

(72) Inventor: John STEWART, Indianapolis, IN (US)

(21) Appl. No.: 15/122,958

(22) PCT Filed: Feb. 26, 2015
(86) PCT No.: PCT/US2015/017718

§ 371 Date: Sep. 1, 2016

Related U.S. Application Data
(60) Provisional application No. 61/948,133, filed on Mar. 5, 2014.

(51) Int. Cl. H04N 21/647; H04N 21/61

(52) U.S. Cl. CPC H04N 21/6473; H04N 21/6112; H04N 21/6168; H04N 21/6175

(57) ABSTRACT

There are provided method and apparatus for multiple device reception. A method performed by a first device and an apparatus includes receiving a signal. The method further includes determining, using a processor, if an error exists in a portion of the received signal, transmitting a request to a second device through a communication network if it is determined that an the error exists in the received signal, the second device being connected to the first device through the communication network and also receiving the signal, the request identifying a portion of the signal to be sent from the second receiver, and replacing the portion of the received signal with the portion of the signal sent from the second device.

### CROSS-REFERENCE TO RELATED APPLICATIONS

This application claims the benefit of U.S. Provisional Application Serial No. 61/948,133, filed Mar. 5, 2014, which is incorporated by reference herein in its entirety.

### TECHNICAL FIELD

The present principles relate generally to multimedia devices and multiple device reception. More specifically, the present principles relate to an apparatus and method for receiving a signal using multiple devices.

### BACKGROUND

Televisions are commonly used household items for signal reception. Accordingly, many households have multiple televisions (TVs) or similar signal receiving device. However, these TVs or devices are subject to errors during signal reception, particularly if the signal, containing audio, video, or data content, is provided as a broadcast channel over the airwaves. Disadvantageously, these errors can impair the viewing experience of a user.

### SUMMARY

These and other drawbacks and disadvantages of the prior art are addressed by the present principles, which are directed to multiple device reception. According to an aspect of the present principles, there is provided a method performed by a first device. The method includes receiving a signal, the signal containing at least one audio, video, and data content broadcast in a channel over airwaves, determining, using a processor, if an error exists in a portion of the received signal, transmitting a request to a second device through a communication network if it is determined that an the error exists in the received signal, the second device being connected to the first device through the communication network and also receiving the signal, the request identifying a portion of the signal to be sent from the second receiver, and replacing the portion of the received signal with the portion of the signal sent from the second device.

According to another aspect of the present principles, there is provided an apparatus. The apparatus includes a receiver circuit for receiving a signal, the signal containing at least one audio, video, and data content broadcast in a channel over airwaves, a loss detector and replacer coupled to the receiving circuit, the loss detector and replacer determining if an error exists in a portion of the signal, and a transceiver circuit coupled to the loss detector and replacer, the transceiver circuit transmitting a request to a device through a communication network if it is determined that an the error exists in the received signal, the request identifying a portion of the signal to be sent from the device; wherein the loss detector and replacer replaces the portion of the signal received from the remote source with the portion of the signal sent from the device.

According to a further aspect of the present principles, there is provided a method performed by a second device connected to a first device through a communication network. The method includes receiving a first request from the first device to tune and receive a signal, the signal containing at least one audio, video, and data content broadcast in a channel over airwaves, receiving a second request from the first device, the request being for the second device to send the first device a portion of the received signal determined by the first device to have a reception error while being received by the first device, and transmitting, the portion of the signal determined by the first device to have the error.

According to yet another aspect of the present principles, there is provided an apparatus. The apparatus includes a receiver that receives a signal containing at least one of audio, video, and data content, and a transceiver, the transceiver receiving a first request from a device through a communication network to receive the signal using the receiver, the transceiver further receiving a second request from the device, the request being to send to the device through the communication network a portion of the received signal determined by the device to have a reception error while being received by the device, the device receiving the signal broadcast in a channel over airwaves, the transceiver also transmitting the portion of the signal determined by the device to have the reception error.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary environment 100 in which the present principles can be applied, according to an embodiment of the present principles;

FIG. 2 shows an exemplary multimedia playback device 200 to which the present principles can be applied, in accordance with an embodiment of the present principles;

FIG. 3 shows an exemplary multiple reception configuration 300 to which the present principles can be applied, in accordance with an embodiment of the present principles;

FIG. 4 shows an exemplary method 400 for multiple device reception, in accordance with an embodiment of the present principles; and

FIG. 5 shows another exemplary method 500 for multiple device reception, in accordance with an embodiment of the present principles.

### DETAILED DESCRIPTION

The present principles are directed to multiple device reception.

The present principles exploit the case that many households have multiple receiving devices (e.g., televisions (TVs)). In such households, many occasions often exist where not all of the receiving devices in a home are in use at the same time. In an embodiment of the present principles, a receiving device that is not currently being used/watched is nonetheless used to recover from errors suffered by a receiving device that is currently being used/watched.

As used herein, “multiple device reception” refers to the reception process performed by a particular receiving device currently in use (i.e., currently being watched) being aided by a different receiving device not currently in use (i.e., not currently being watched). The phrase “multiple device reception” is intended to apply to any number (i.e., one or more) of currently used receiving devices and any number (i.e., one or more) of currently unused receiving devices.

While one or more embodiments of the present principles are directed to televisions, it is to be appreciated that the present principles are not limited to solely televisions and other types of receiving devices can be used in accordance with the teachings of the present principles, while remaining within the scope of the present principles. For example, the receiving devices can be any of televisions, set top boxes, gateways, game consoles, a computer device with a receiver (e.g., a desktop, laptop, tablet, e-reader, personal digital assistant, smart phone, etc.), and so forth. Of course, embodiments of the present principles can involve a mix of different types of receiving devices or the same type of receiving devices. These and other variations of the present principles are readily determined by one of ordinary skill in the art given the teachings of the present principles provided herein, while maintaining the spirit of the present principles.

As an example, consider a person watching a channel on the main TV in the living room (TV1), with an unused TV in the bedroom (TV2). TV1 may contact TV2 over the Ethernet, internet, or other wired or wireless connection and have TV2 tune to the same channel as TV1. The screen of TV2 does not have to be in use, just the receiver and processing circuits. If TV1 receives an uncorrectable error during signal reception, TV1 may contact TV2 and request the corrupted packet. TV2 sends the packet to TV1 which then insert it into its data stream.

Accordingly, while one or more embodiments described herein relate to the reception of a single currently used receiving device being aided by a single unused receiving device, in other embodiments the reception of more than one currently used receiving device can be aided by a single unused receiving device. In fact, all or a subset of the currently used receiving devices can be aided by all or a subset of the unused receiving devices. The assignments can be dynamically assigned (e.g., depending on which receiving devices are currently being used/not used, location, reception abilities, and/or so forth.) or pre-configured. These and other variations of the present principles are readily determined by one of ordinary skill in the art given the teachings of the present principles provided herein, while maintaining the spirit of the present principles.

Additionally, while one or more embodiments described herein relate to receiving devices connected via an Ethernet protocol, the present principles are applicable to practically any communication medium and protocol. Thus, wired protocols, such as multimedia or cable alliance (MoCA) protocol as well as wireless communication protocols, such as the Institute of Electrical and Electronics Engineers (IEEE) 802.11 protocol, can be used. Further, the present principles may be expanded to encompass multiple receiving devices located at different locations (e.g., different homes) and operating cooperatively to receive a signal and correct errors. These and other variations of the present principles are readily determined by one of ordinary skill in the art given the teachings of the present principles provided herein, while maintaining the spirit of the present principles.

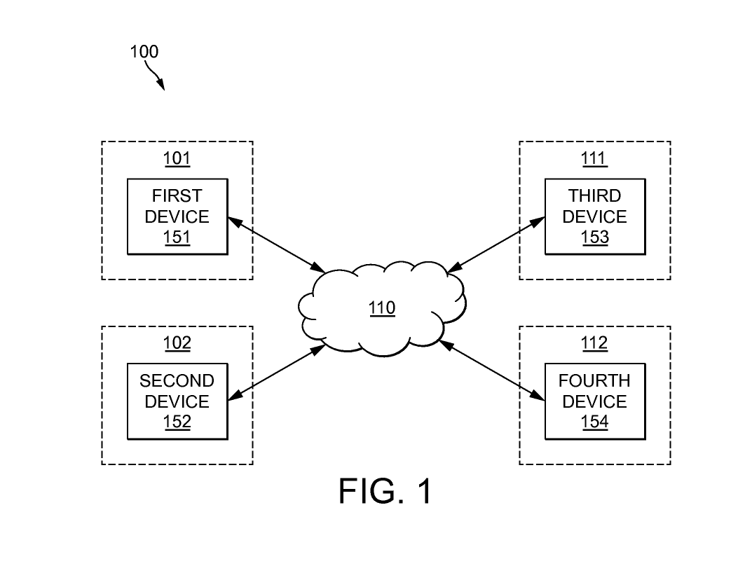

FIG. 1 shows an exemplary environment 100 in which the present principles can be applied, according to an embodiment of the present principles. The environment 100 involves a home, and includes four receiving devices, namely a first device 151, a second device 152, a third device 153, and a fourth device 154. The first device 151, the second device 152, the third device 153, and the fourth device 154 are connected to each other through a local network 110. The first device 151 is located in a first den 101. The second device 152 is located in a second den 102. The third device 153 is located in a first bedroom 111. The fourth device 154 is located in a second bedroom 112.

In the embodiment of FIG. 1, the first device 151 and the second device 152 are currently in use/being watched, while the third device 153 and the fourth device 154 are currently not in use/not being watched. Thus, the third device 153 and the fourth device 154 serve to aid the reception of the first device 151 and the second device 152. To that end, both the third device 153 and the fourth device 154 can be configured to aid the reception of both the first device 151 and the second device 152. Alternatively, one of the third device 153 or the fourth device 154 is configured to aid the reception of the first device 151, while the other one of the third device 153 or the fourth device 154 is configured to aid the reception of the second device 152. Of course, other assignments can be made, including the devices switching roles after a certain time of day (e.g., when the occupants of the first bedroom and the second bedroom retire for the evening, but watch programming in their rooms before actually going to sleep.

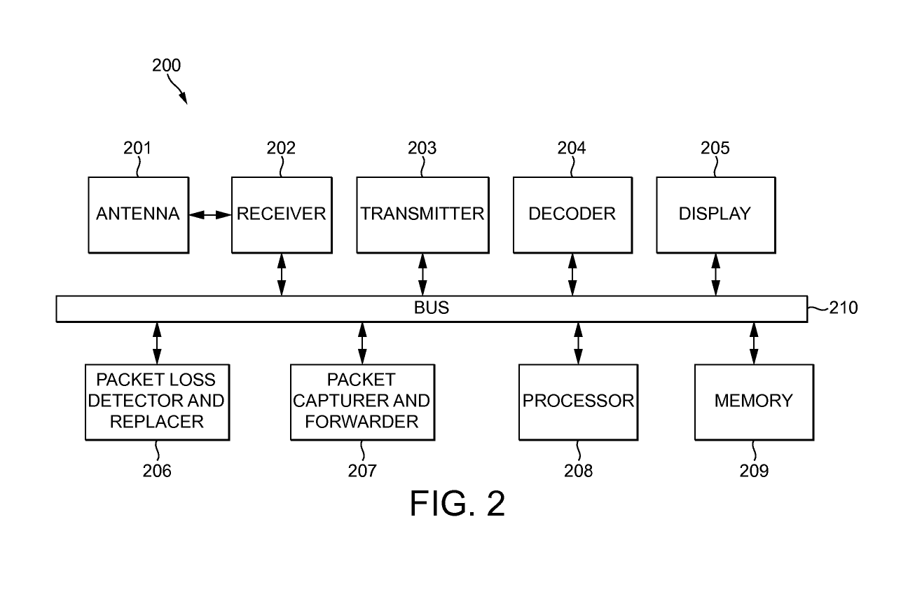

FIG. 2 shows an exemplary receiving device 200 to which the present principles can be applied, in accordance with an embodiment of the present principles. The receiving device 200 includes an antenna 201, a receiver 202, a transmitter 203, a decoder 204, a display 205, a packet loss detector and replacer 206, a packet capturer and forwarder 207, a processor 208, and a memory 209. The receiver 202 is coupled to the antenna 201. Receiver 202, transmitter 203, decoder 204, display 205, packet loss detector and replacer 206, packet capturer and forwarder 207, processor 208, and memory 209 are interconnected by bus 210.

While shown as standalone elements, a processor and memory can be incorporated into one or more of the other elements of the receiving device 200. Moreover, in another embodiment, the packet loss detector and replacer 206 and/or the packet capturer and forwarder 207 can be incorporated into the decoder 204. Further, in another embodiment, a transceiver may be used in place of the receiver 202 and transmitter 203. These and other variations of the elements of FIG. 2 are readily contemplated by one of ordinary skill in the art given the teachings of the present principles provided herein, while maintaining the spirit of the present principles.

In an embodiment, the receiving device 200 is a television. However, in other embodiments, the receiving device 200 can be a set top box, a gateway, a desktop computer, a laptop computer, a tablet, and so forth.

It is to be appreciated that the present principles are primarily directed to the reception of a signal by a television where such reception is aided by another television(s) that is currently not being watched. However, as noted above, the present principles can be applied to any receiving device(s) capable of implementing the present principles, as readily determined by one of ordinary skill in the art given the teachings of the present principles provided herein.

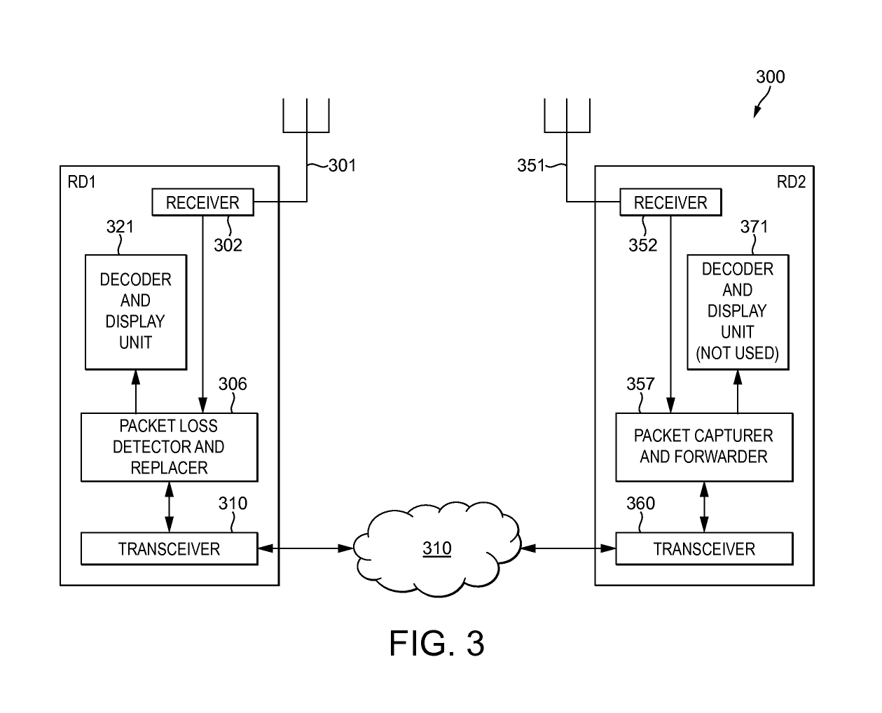

FIG. 3 shows an exemplary multiple reception configuration 300 to which the present principles can be applied, in accordance with an embodiment of the present principles. The configuration 300 involves receiving devices, the receiving devices being similar in operation and function to receiving device 200 described in FIG. 2, except where noted below. However, while only two devices are shown, the present principles are not limited to solely two devices and, thus, more than two devices can be used while maintaining the spirit of the present principles.

In the embodiment of FIG. 3, the multiple reception configuration 300 includes and/or otherwise involves a first receiving device (RD1) and a second receiving device (RD2) connected to each other over a local network 310. The local network 310 can involve one or more technologies and/or protocols. For example, the local network 310 can involve wired and/or wireless protocols. In an embodiment, the local network 310 is Ethernet-based. In another embodiment, the local network 310 is a wireless home network. Of course, other types of networks can also be used, while maintaining the spirit of the present principles.

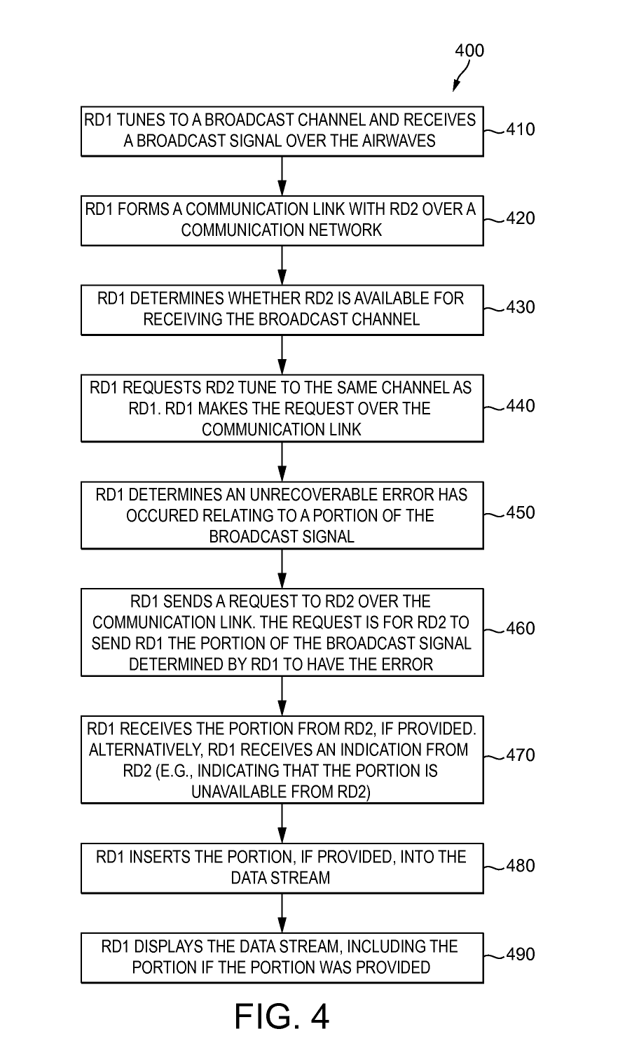

For the sake of simplicity and illustration, the main elements of the receiving devices involved in the method 400 of FIG. 4 are similar to those shown in FIG. 3. Thus, different elements may be shown with respect to RD1 and RD2 to illustrate the elements that are implicated in the illustrated embodiment of the present principles shown in FIG. 3. That is, the implicated elements of the televisions are dependent on the role a given television is to serve in the multiple reception scheme according to the present principles. The elements shown with respect to RD1 are representative of the elements implicated for a receiving device whose reception is to be aided by another receiving device, while the elements shown with respect to RD2 are representative of the elements implicated for a receiving device that is to aid the reception of another receiving device. Moreover, in the embodiment of FIG. 3, the decoder and display have been combined into a single unit, and that unit is denoted as “not used” in RD2 since RD2 is being used to aid in the reception by RD1.

Thus, RD1 has an antenna 301, a receiver 302, a decoder and display unit 321, a packet loss detector and replacer 306, and a transceiver 310. RD2 has an antenna 351, a receiver 352, a decoder and display unit 371, a packet capturer and forwarder 357, and transceiver 360. Transceiver 310 and transceiver 360 operate in a manner similar to transmitter 203 and/or receiver 202 in FIG. 2 and are used for communication on a local communication network (e.g., home network).

In terms of physical location, it would be beneficial if the receivers 302, 352 were some distance apart if they are using separate antennas. The distance allows for a decorrelation of the received signals between the two receivers 302, 352 so that the errors that may occur during reception may also be somewhat decorrelated. The optimal distance of separation may depend upon the receiving frequency, but if receivers 302, 352 are in different rooms of a house/apartment, then they will most likely have adequate separation.

The purpose of the second receiver (e.g. receiver 352) is to have a second source of received signal that can be used for error packet replacement. It is to be appreciated that both of the receivers could have the capability of being either the receiver of correction packets, or the source of the correction packets. The primary difference is that at some point in time, probably only one of the two devices would be actively in use. For example, receiver 1 is in the living room and receiver 2 is in the bedroom. At the beginning of the evening someone is watching a program in the living room. In this case, the receiver in the bedroom is not actively used so the receiver in the living room uses the bedroom receiver as a source of correction packets. Later in the evening, the person goes to bed and starts watching the receiver in the bedroom. In this case, no one is actively using the receiver in the living room, so the two receivers switch functions. Now, the receiver in the bedroom is receiving correction packets and the receiver in the living room is the source of the correction packets.

The present principles advantageously exploit having at least two receivers, each with its own antenna, as opposed to having a single device with multiple antennas located proximately. It is to be appreciated that a primary improvement in the receiving quality obtained by the present principles is due to using two antennas at least located non-proximately. However, there may also be an improvement with having multiple receivers as one of the receivers may be of higher quality that the others. The setup described herein involving at least two receivers, each with its own antenna, takes advantage of a situation that already exists in many homes. In some operating setups, an optimal receiving condition may include installing multiple antennas connected to a single receiver that has the capability to take advantage of multiple antennas. However, this is an expensive and complex solution that requires a professional installation. A more common situation is that multiple receiving devices (e.g., TVs) are located in various rooms in a residence. The receiving devices may hook into an existing antenna system or may have or simply use the devices' built in antennas. The present principles advantageously take advantage of this normal installation to get some improvement in performance without requiring complex/expensive installations.

FIG. 4 shows an exemplary method 400 for multiple device reception, in accordance with an embodiment of the present principles. The method 400 involves a person watching a channel on a first receiving device (RD1) in a home with an unused receiving device (RD2) also located in the home. The method 400 corresponds to the steps performed by RD1.

At step 410, RD1 tunes to a broadcast channel and receives a broadcast signal over the airwaves.

At step 420, RD1 forms a communication link with RD2 over a communication network. The communication network can be, for example, but is not limited to, a local area network (LAN).

At step 430, RD1 determines whether RD2 is available for receiving the broadcast channel. Such determination is made with respect to RD2 serving in a support role with respect to RD1. Thus, for example, the determination can simply involve whether RD2 is capable of receiving the broadcast channel and whether RD2 is currently being used (watched). Such determination can be made using a request for availability sent from RD1 to RD2 and a corresponding response sent from RD2 to RD1. In other embodiments, the availability of RD2 can be presumed. These and other ways to determine the availability of RD2 are readily determined by one of ordinary skill in the art given the teachings of the present principles provided herein, while maintaining the spirit of the present principles.

At step 440, RD1 requests RD2 tune to the same channel as RD1. RD1 makes the request to RD2 over the communication link. Regarding the request, the display of RD2 would not be used, just the receiving and processing circuits.

At step 450, RD1 determines an unrecoverable error has occurred relating to a portion of the broadcast signal. The portion can be a packet. The packet can be corrupted or simply not received by RD1. For the purposes of the present principles, in an embodiment, it is presumed that RD2 received the portion without error.

At step 460, RD1 sends a request to RD2 over the communication link. The request is for RD2 to send RD1 the portion of the broadcast signal determined by RD1 to have the error.

At step 470, RD1 receives the portion from RD2, if provided. In an embodiment, RD2 can determine that it also received the portion with error and, if so, then provides an indication to RD1 in place of providing the portion to RD1. The indication basically informs RD1 that the portion cannot be provided from RD2. This allows RD1 to request the portion from another television or perform error correction or error concealment to correct or conceal the error, respectively, during a reproduction of the corresponding data stream for a user.

At step 480, RD1 inserts the portion, if provided, into the data stream. The insertion can involve replacing the portion received by RD1 over the airwaves with the portion provided by RD2 over the communication link.

At step 490, RD1 displays the data stream, including the portion if the portion was provided.

A further description will now be given regarding how the transfer between devices is performed, in accordance with an embodiment of the present principles. It is to be appreciated that there could be many methods of transferring the data. In an embodiment, the transfer is performed with respect to Advanced Television Systems Committee (ATSC) Version 2.0 or 3.0 standards, there would be a requirement for an Ethernet connection (either wired or wireless) on receiving devices. Already, many TVs are sold with Ethernet connections or Wi-Fi connections. In this case, the requesting device would send an IP packet with a request for a specific packet. The specific packet would be identified through the use of whatever protocol is in use at the time. For example, if the protocol is MPEG transport, then there are packet counters that could be used to identify a specific packet. If the protocol is Real-time Transport Protocol (RTP), then it might be a Network Abstraction Layer (NAL) unit. The second device would get the requested packet from a buffer, encapsulate this in an IP packet and send back to the requesting device. This exchange would most likely be done via a Transmission Control Protocol (TCP) socket connection between the two devices. However, the data transfer could take place over any number of connections including a dedicated wired connection. These and other ways to perform the transfer between devices are readily determined by one of ordinary skill in the art given the teachings of the present principles provided herein, while maintaining the spirit of the present principles.

A further description will now be given regarding step 480, in accordance with an embodiment of the present principles. This replacement scheme may require some amount of buffering on one or both devices. In FIG. 3, a memory located in packet loss detector and replacer 306 and the packet capturer and forwarder 357 to provide signal buffering, introducing a delay to the signal. Buffering may be necessary in the primary receiver so that a request may be made to a secondary device and a response received. In an exemplary embodiment, communication a home network fairly short communication link time(e.g., <100 ms). This short communication link time may require a relatively small amount of memory for the buffer (e.g., ˜256 KByte). In some embodiments, the memory may be larger to allow for worst case conditions. The devices that are receiving the requests for packets also need to have some buffer memory of approximately the same order and size.

Once a correction packet is received, it would be reinserted in the proper location by the packer loss detector and replacer 306, the output of which goes to the decoder and display unit as a media stream of some type. This could be an MPEG transport stream, for example, or any media stream format that might be in use at the time.

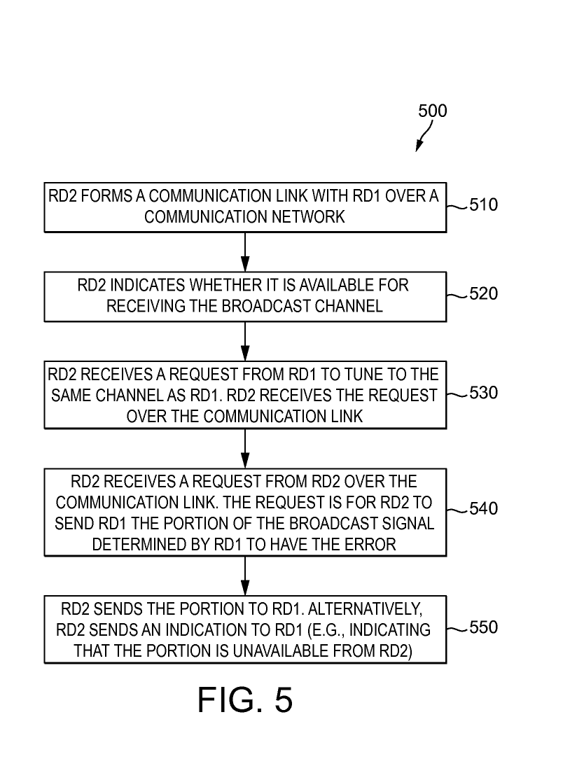

FIG. 5 shows another exemplary method 500 for multiple device reception, in accordance with an embodiment of the present principles. The method 500 involves a person watching a channel on a first receiving device (RD1) in a home with an unused receiving device (RD2) also located in the home. The method 500 corresponds to the steps performed by RD2.

At step 510, RD2 forms a communication link with RD1 over a communication network. The communication network can be, for example, but is not limited to, a local area network (LAN).

At step 520, RD2 indicates whether it is available for receiving the broadcast channel. Such indication is made with respect to RD2 serving in a support role with respect to RD1. Thus, for example, the indication can simply involve whether RD2 is capable of receiving the broadcast channel and whether RD2 is currently being used (watched). Such indication can be made using a request for availability sent from RD1 to RD2 and a corresponding response sent from RD2 to RD1. In other embodiments, the availability of RD2 can be presumed. These and other ways to determine the availability of RD2 are readily determined by one of ordinary skill in the art given the teachings of the present principles provided herein, while maintaining the spirit of the present principles.

At step 530, RD2 receives a request from RD1 to tune to the same channel as RD1. RD2 receives the request from RD1 over the communication link. Regarding the request, the display of RD2 would not be used, just the receiving and processing circuits.

At step 540, RD2 receives a request from RD1 over the communication link. The request is for RD2 to send RD1 the portion of the broadcast signal determined by RD1 to have the error.

At step 550, RD2 sends the portion to RD1, if available. In an embodiment, RD2 can determine that it also received the portion with error and, if so, then provides an indication to RD1 in place of providing the portion to RD1. The indication basically informs RD1 that the portion cannot be provided from RD2. This allows RD1 to request the portion from another television or perform error correction or error concealment to correct or conceal the error, respectively, during a reproduction of the corresponding data stream for a user.

Thus, as mentioned above, there could be cases where both receiving devices could not receive a particular packet depending upon the source of the error. If the receiving devices are fed from different antennas (e.g., internal antennas), then there is a good likelihood that the corrupted packets on the two receiving devices will be uncorrelated. Even if the receiving devices are fed from the same antenna, there is still some likelihood that one of the two receiving devices will have a better receiving circuit and will be able to receive the signal. Also, it may be the case that newer houses have an Ethernet cable running throughout the home, but not coaxial cable. If one of the receiving devices had access to a good antenna, it could be used to help the other receiving devices which might only have an internal antenna. These and other applications and situations to which the present principles can be applied are readily determined by one of ordinary skill given the teachings of the present principles provided herein, while maintaining the spirit of the present principles.

Moreover, while the embodiments of FIGS. 3-5 are described as involving only two receiving devices, it is to be appreciated that other embodiments can involve more than two receiving devices. These and other variations of the present principles are readily determined by one of ordinary skill in the art given the teachings of the present principles provided herein, while maintaining the spirit of the present principles.

Thus, the present principles exploit the fact that many households have multiple receiving devices but rarely are all the receiving devices in use at the same time. The idea is to use a connection(s) between the receiving devices to allow unused receiving devices to contribute to the signal quality of the receiving devices that are used. The connection(s) can be wired and/or wireless. The connections can be based on the Ethernet protocol or some other protocol.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method performed by a first device, comprising:
receiving a signal, the signal containing at least one of audio, video, and data content broadcast in a channel over airwaves;
determining, using a processor, if an error exists in a portion of the received signal;
transmitting a request to a second device through a communication network if it is determined that an the error exists in the received signal, the second device being connected to the first device through the communication network and also receiving the signal, the request identifying a portion of the signal to be sent from the second receiver; and
replacing the portion of the received signal with the portion of the signal sent from the second device.

2. The method of claim 1, further comprising forming a communication link over the communication network to the second device, the second device being capable of receiving the broadcast signal.

3. The method of claim 2, further comprising determining whether the second device is available for receiving the broadcast channel.

4. The method of claim 3, further comprising transmitting a request to the second device to tune to and receive the broadcast channel responsive to the second device determined to be available for receiving the broadcast channel.

5. The method of claim 1, wherein the second device uses a different method to receive the broadcast channel.

6. The method of claim 5, wherein the different method involves using a different antenna.

7. The method of claim 1, wherein the portion is a packet of data.

8. The method of claim 1, wherein the communication network is a home wireless network.

9. The method of claim 1, wherein the communication network uses at least one of Ethernet protocol and Multimedia over Cable Alliance protocol.

10. The method of claim 1, wherein the second device is located outside of a user's home in which the first device is located.

11. The method of claim 1, wherein the first device is a first television currently being watched, and the second device is a second television currently being unwatched.

12. A non-transitory article of manufacture tangibly embodying a computer readable program which when executed causes a computer to perform the steps of claim 1.

13. An apparatus, comprising:
a receiver circuit for receiving a signal, the signal containing at least one of audio, video, and data content, the signal being broadcast in a channel over airwaves;
a loss detector and replacer coupled to the receiving circuit, the loss detector and replacer determining if an error exists in a portion of the received signal; and
and a transceiver circuit coupled to the loss detector and replacer, the transceiver circuit transmitting a request to a device through a communication network if it is determined that an the error exists in the received signal, the request identifying a portion of the signal to be sent from the device; wherein the loss detector and replacer replaces the portion of the received signal with the portion of the signal sent from the device.

14. The apparatus of claim 13, wherein the transceiver circuit forms a communication link over the communication network to the device, the device being capable of receiving the signal.

15. The apparatus of claim 14, further comprising a processor that determines whether the device is available for receiving the signal.

16. The apparatus of claim 15, wherein the transceiver circuit transmits a request to the device to tune to and receive the signal responsive to a determination that the device is available for receiving the signal.

17. The apparatus of claim 13, wherein the device receives the signal in a manner that is different from the apparatus.

18. The apparatus of claim 17, wherein the device receives the signal using a different antenna.

19. The apparatus of claim 13, wherein the portion is a packet of data.

20. The apparatus of claim 13, wherein the communication network is a home wireless network.

21. The apparatus of claim 13, wherein the communication network uses at least one of Ethernet protocol and Multimedia over Cable Alliance protocol.

22. The apparatus of claim 13, wherein the second device is located outside of a user's home in which the first device is located.

23. The apparatus of claim 13, wherein the apparatus is a first television currently being watched, and the device is a second television currently being unwatched.

24. A method performed by a second device connected to a first device through a communication network, comprising:
receiving a first request from the first device to receive a signal, the signal containing at least one of audio, video, and data content;
receiving a second request from the first device, the request being for the second device to send the first device a portion of the received signal determined by the first device to have a reception error while being received by the first device, the first device receiving the signal broadcast in a channel over airwaves; and
transmitting, the portion of the signal determined by the first device to have the reception error.

25. The method of claim 24, wherein the first device and the second device each include a respective display element, the display element of the first device being used while the display element of the second device is unused.

26. The method of claim 25, wherein the first device is a first television currently being watched, and the second device is a second television currently being unwatched.

27. The method of claim 24, wherein the portion is a packet of data.

28. The method of claim 24, wherein the communication network is a home wireless network.

29. The method of claim 24, wherein the communication network uses at least one of Ethernet protocol and Multimedia over Cable Alliance protocol.

30. A non-transitory article of manufacture tangibly embodying a computer readable program which when executed causes a computer to perform the steps of claim 24.

31. An apparatus, comprising:
A receiver that receives a signal containing at least one of audio, video, and data content; and
a transceiver, the transceiver receiving a first request from a device through a communication network to receive the signal using receiver, the transceiver further receiving a second request from the device, the request being to send to the device through the communication network a portion of the received signal determined by the device to have a reception error while being received by the device, the device receiving the signal broadcast in a channel over airwaves, the transceiver also transmitting the portion of the signal determined by the device to have the reception error.

32. The apparatus of claim 31, wherein the apparatus and the device each include a respective display element, the display element of the device being used while the display element of the apparatus is unused.

33. The method of claim 32, wherein the apparatus is a first television currently being unwatched, and the device is a second television currently being watched.

34. The apparatus of claim 31, wherein the portion is a packet of data.

35. The apparatus of claim 31, wherein the communication network is a home wireless network.

36. The method of claim 31, wherein the communication network uses at least one of Ethernet protocol and Multimedia over Cable Alliance protocol.
